(19) United States
(12) Patent Application Publication
(10) Pub. No.: US 2018/0031599 A1
(43) Pub. Date: Feb. 1, 2018

(54) OPTICALLY ENABLED MICRO-DISK INERTIA SENSOR

(71) Applicant: Khalifa University of Science and Technology, Abu Dhabi (AE)

(72) Inventors: Mahmoud Rasras, Abu Dhabi (AE); Ghada Dushaq, Abu Dhabi (AE)

(21) Appl. No.: 15/633,886

(22) Filed: Jun. 27, 2017

Related U.S. Application Data
(60) Provisional application No. 62/367,132, filed on Jul. 27, 2016.

(51) Int. Cl. G01P 15/093; G01P 15/18; G01P 15/08

(52) U.S. Cl. CPC G01P 15/093; G01P 15/0802; G01P 15/18; G02B 6/126

(57) ABSTRACT

A micro-opto-mechanical sensor device comprises a substrate; a moveable structure on the substrate and supported by a plurality of flexible supports, the moveable structure being spaced apart from the substrate; and an optical waveguide between the moveable structure and the substrate, wherein movement of the moveable structure attenuates light in the optical waveguide.

### RELATED APPLICATIONS

This application claims priority to U.S. Provisional Application Ser. No. 62/367,132, filed Jun. 27, 2016, the disclosure of which is hereby incorporated by reference in its entirety.

### FIELD OF THE INVENTION

The present invention relates to micro-disk inertia sensors, and in particular, to micro-disk inertia sensors incorporating optical waveguides.

### BACKGROUND

Electronic products increasingly use motion based sensing and control to improve interaction between users and their devices. Motion based control is a fast growing integration aspect in modern portable devices. Having a sensing apparatus able to detect inertia motion, acceleration or angular velocity introduces numerous applications that bring closer interaction between hardware and software functions.

Silicon Micro-Electro-Mechanical Systems (MEMS) devices are widely used for inertia and pressure sensing applications. Traditional MEMS inertia sensor designs employ a large proof mass attached to springs which yields resonant frequency of a few kilohertz. A variety of transduction mechanisms have been used for sensing the proof mass displacement. These mechanisms include piezoresistive, tunneling, thermal, capacitive, and optical mechanisms. Optically enabled micro-accelerometers can offer high resolution detection and improved sensitivity. These sensors are resistant to electromagnetic interference and have the potential to be integrated with electronics on the same silicon platform. Such platforms can provide compact device size in addition to a low fabrication cost when produced in mass. Optical micro-accelerometers have been used in wide range of applications including: biomedical, industrial processes such as robotics, human-activities monitoring and consumer electronics.

The quality of an accelerometer is specified by its sensitivity, maximum operation range, frequency response, resolution, off-axis sensitivity, and shock survival. In addition, a trade-off between the sensor's sensitivity and bandwidth should be attained. For example, low resonance frequencies yield large displacements and result in a good sensor resolution but restrict the sensor's bandwidth. Capacitive accelerometers reduce the trade off between sensitivity and bandwidth by implementing a feedback circuit. Optically enabled inertia sensors are able to achieve sub nm/g resolution with smaller masses. An optical detection based system employs optical resonators or photonics crystal cavities with narrow transmission bandwidth. Therefore, such devices require tunable lasers with complex control of their resonance wavelength to align with that of the optical resonator. Consequently, these systems are complex in nature and add more complexity to the system.

### SUMMARY OF EMBODIMENTS OF THE INVENTION

In some embodiments, a micro-opto-mechanical sensor device comprises a substrate; a moveable structure on the substrate and supported by a plurality of flexible supports, the moveable structure being spaced apart from the substrate; and a passive optical waveguide between the moveable structure and the substrate, wherein movement of the moveable structure attenuates light in the optical waveguide.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram perspective view of a silicon nitride suspended waveguide according to some embodiments.

FIG. 2 is a cross sectional view of a hybrid integration of SOI and IMU platform layers according to some embodiments.

FIG. 3A is a top view of the proposed suspended inertial disk according to some embodiments.

FIG. 3B is a schematic diagram of a serpentine spring according to some embodiments.

FIGS. 4A, 4B and 4C are perspective views of the inertial disk according to some embodiments that illustrate three vibration modes of the inertia sensor and their corresponding resonance frequency values, FIG. 4A Mode 1 with 2.1 kHz; FIG. 4B Mode 2 with 3.6 kHz; and FIG. 4C Mode 3 with 3.6 kHz.

FIG. 5A is a graph of the maximum displacement of an out-of-plane loaded inertia sensor according to some embodiments.

FIG. 5B is a graph of the maximum displacement of an in-plane loaded inertia sensor according to some embodiments.

FIGS. 6A, 6B and 6C are graphs of three vibrational modes of the suspended beam (Si3N4 waveguide) according to some embodiments, FIG. 6A Mode 1 with 1 MHz;

FIG. 6B Mode 2 with 2.2 MHz; FIG. 6C Mode 3 with 2.8 MHz.

FIG. 7 is a graph of a time response of inertia sensor under a sudden acceleration pulse of width 0.1 ms according to some embodiments.

FIGS. 8A and 8B are digital images of mode shapes of 0.35 μM width Si₃N₄/SiO₂ waveguide showing a TE mode (FIG. 8A) and a TM mode (FIG. 8B) according to some embodiments.

FIGS. 9A and 9B are graphs of the power leakage of Si₃N₄ waveguide modes at a waveguide length of 50 μm for TE mode (FIG. 9A) and a TM mode (FIG. 9B) according to some embodiments.

FIG. 10 is a graph of the power leakage of TE and TM modes of 0.35 μm width Si₃N₄ waveguide according to some embodiments.

FIG. 11 is a graph of the power leakage of 0.35 μm width Si₃N₄ waveguide as a functional length according to some embodiments.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

In some embodiments, a micro-opto-mechanical sensor device comprises a substrate and a moveable structure, such as a disk-shaped proof mass, on the substrate and supported by a plurality of flexible supports. The moveable structure is spaced apart from the substrate, and an optical waveguide is between the moveable structure and the substrate such that movement of the moveable structure attenuates light in the optical waveguide. Accordingly, a disk proof mass may be integrated on top of an optical waveguide, and the optical power of a laser beam propagating in the waveguide located under the disk is attenuated in response to the vertical movement of the disk.

The optical waveguide may include a core comprising silicon (Si) or silicon nitride (Si₃N₄). The optical waveguide may include an outer cladding layer around the optical waveguide core, and the outer cladding is reduced or removed on a side of the optical waveguide core that is adjacent the substrate and opposite the moveable structure. The optical waveguide may be configured to transmit at least one of transverse electric (TE) or transverse magnetic (TM) optical polarizations. The optical waveguide may be a birefringent, passive optical waveguide.

Although embodiments according to the present invention are described herein with respect to movement in the vertical or z-direction, it should be understood that an optically-enabled micro-disk inertia sensor includes a suspended disk shape proof mass that has the flexibility to move in three dimensions (3-axes). The movement may be detected as described herein by placing a waveguide, such as a birefringent waveguide, under the proof mass separated by an air gap. In particular embodiments, the proof mass may be designed using an Inertial Measurement Unit (IMU) platform and the waveguide may be a silicon photonics (SiPh) device. The proof mass structure may be suspended using one or more serpentine springs (in particular embodiments, four serpentine springs are used), where the serpentine springs are designed to provide a low spring constant and are optimized to allow maximum displacement in the out-of-plane direction. This movement may be detected using birefringent suspended hybrid waveguides integrated under the proof mass. In yet another embodiment, the hybrid waveguides are constructed using relatively low-index-contrast silicon nitride (Si₃N₄) waveguides which can transmit either transverse electric (TE) or transverse magnetic (TM) optical polarizations.

In some embodiments, the detection of light intensity transmission modulation in a passive waveguide may reduce or eliminate the tedious tuning of optical resonators, which may simplify the detection method, and in addition, low cost lasers may be used. Accordingly, the optical waveguide may be devoid of optical resonators and photonics cavities in some embodiments. In particular embodiments, the optically enabled micro-disk inertia sensor has a dynamic range up to 10 g of operation. The TE and TM light modes in a relatively low-index-contrast Si₃N₄ suspended waveguide may be used. The two light modes showed different behavior in light intensity modulation, and the etched bottom cladding waveguide TM mode was highly sensitive to any out of plane movement, recording ˜25 dB/μm change in light intensity for 0.25 μm Si₃N₄ width. The out of plane optical displacement detection and the time response behavior of the optically enabled micro-disk inertia sensor may provide improved motion detection and a smart user interface. In other embodiments, a straight waveguide having a TM component of 50 μm (L×W=50×0.35 μm²) was used to detect the course movement. The second straight waveguide structure having a TM component of 100 μm (L×W=100×0.35 μm²) was used to detect the fine movement of the disk. In another embodiment, the low cost and high detection capability of the optically enabled micro-disk inertia sensor design does not require additional components for functional utility, such as tunable optical resonators or photonics cavities.

In some embodiments, an optically enabled micro-disk inertia sensor includes a proof mass suspended by beams (serpentine springs) which were anchored to a fixed frame and the system can be modeled by second-order mass-damper-spring system. The out-of-plane (z) movement is detected by two sets of nano-photonic waveguides which are placed under the proof mass.

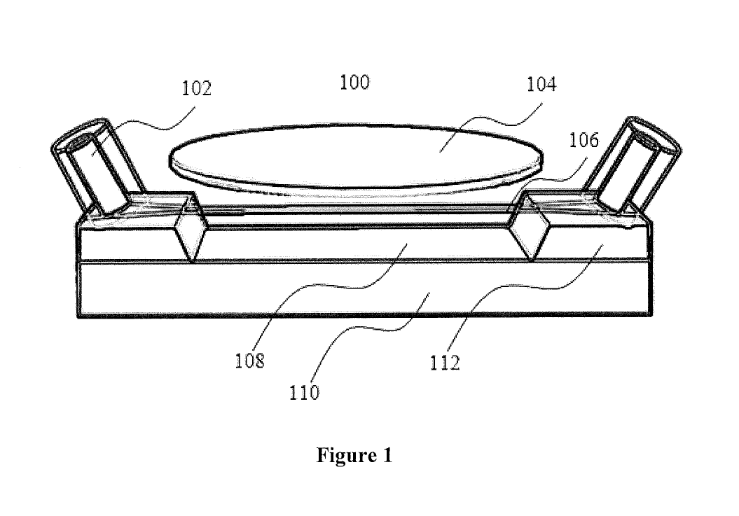

With reference to FIG. 1, a micro-opto-mechanical sensor device 100 according to some embodiments using a relatively low index-contrast silicon nitride (Si3N4) platform is shown. The device includes two optical fiber components 102 that are situated on both ends of the silicon nitride device 100. In the center, an inertia disk 104 is positioned in between the optical fiber components 102. The optical fiber components 102 are situated on two box supports 112 and are fixed on a base silicon substrate 110. Air 108 passes through a suspended Si₃N₄ waveguide 106 and the inertia disk 104.

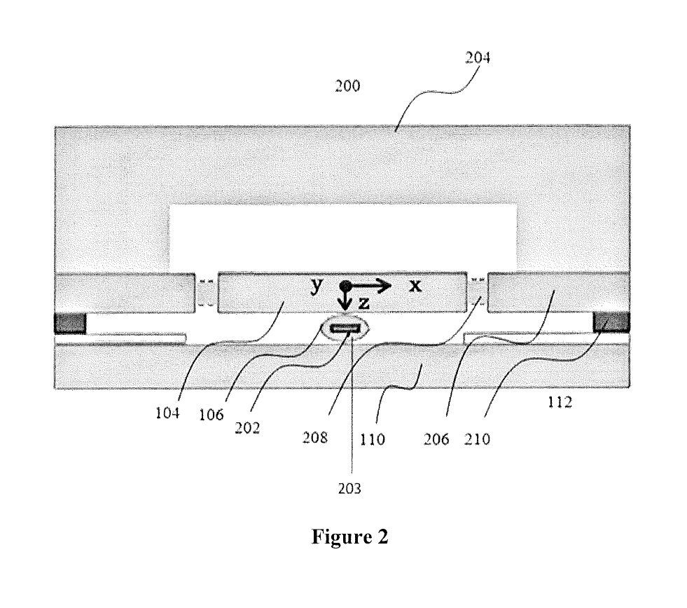

In a proposed hybrid integrated platform device 100, a substrate or silicon on insulator (SOI) wafer (Si-substrate photonics layer) 110 was bonded to a layer, such as an inertia measurement unit (IMU) wafer or platform 204 where the initial gap between the two wafers is 1 μm, as shown in FIG. 2. FIG. 2 illustrates a similar exemplary schematic of the waveguide as in FIG. 1 from a 90 degree cross section point of view. The hybrid integrated platform device 200 in FIG. 2 includes an optical waveguide 106 with a center core of Si or Si₃N₄ 202, situated in between Si-substrate photonics 110 and an x, y, z direction movable proof mass 104 in the center of the device 200. The Si-substrate photonics layer 110 is situated on one side of the device 200 and on the other is a Si-substrate IMU platform 204, which is a cavity structural layer for the proof mass 200 and, in some embodiments, encases the entire proof mass or inertia disk 104. A structural layer 206 connects to the waveguide supports 210 and the inertia disk 104 through a spring flexible support 208. The support 210 acts as a spacer between the inertia disk support layer 206 and box supports to enable flexible movement for the inertia disk 104.

As illustrated, the waveguide 106 includes a cladding layer 203 that surrounds the core 202. In some embodiments, the outer cladding layer 203 is reduced or removed (e.g., etched away) on a side of the optical waveguide core 202 that is adjacent the substrate 110 and opposite the moveable disk 104, which may improve optical interactions with the disk 104. The waveguide 106 may be adiabatically tapered in a region in which the waveguide optically interacts with the disk 104.

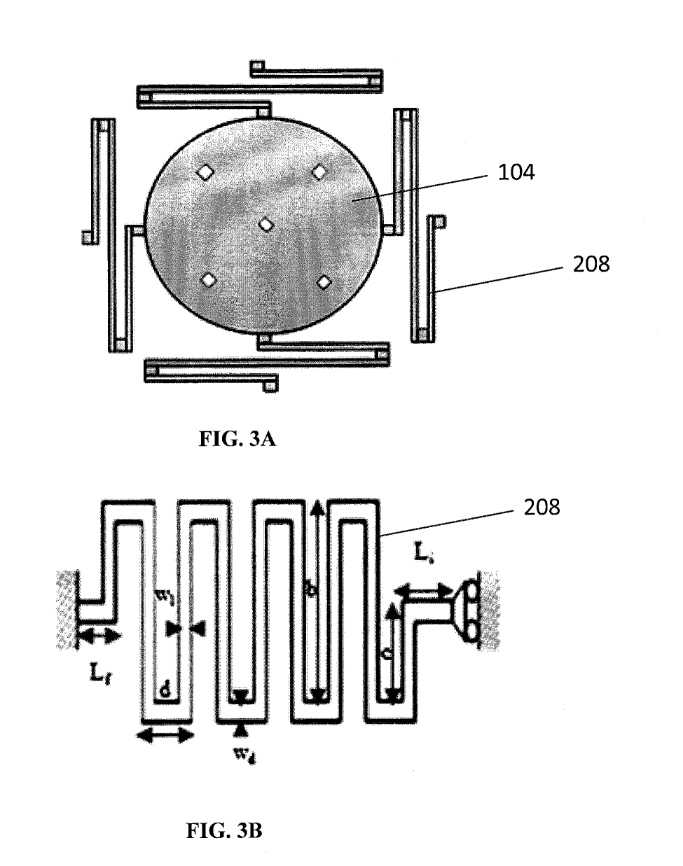

FIG. 3B shows a schematic of the optically enabled micro-disk inertia sensor. Classic serpentine springs 208 are used to support the disk 104 in this design because these springs offer a low spring constant and occupy a reasonable area. Furthermore, the serpentine springs 208 can be used for the in-plane as well as the out-of-plane displacements and have properties of a torsional spring. The resonant frequency of serpentine springs design are completely independent of residual stress value, while there is a large stress dependence for simple straight torsional rods with the same spring constants. The stiffness of serpentine springs and other beams shape were calculated based on the standard small displacement beam theory.

The static, modal analysis, and the transient response of the inertia sensor simulated was conducted using COMSOL Multi-Physics application. The design parameters of the inertia sensor are summarized in Table 1.

TABLE 1
Design parameters of the optically enabled micro-disk inertia sensor.

| Design | | |
|---|---|---|
| parameter | Value (μm) | Expression |
| Li | 100 | The length of the initial part of the |
| | | serpentine |
| Wi | 100 | The width of the initial part of the |
| | | serpentine |
| Lf | 100 | The length of the final part of the |
| | | serpentine |
| Wf | 100 | The width of the final part of the serpentine |
| Wl | 80 | The width of the beam |
| D | 260 | The turn length |
| B | 2000 | The beam length |
| C | 1000 | c = b/2 |
| N | 4 | Number of turns |
| T | 30 | The thickness of the whole structure |
| R | 1500 | Proof mass radius |

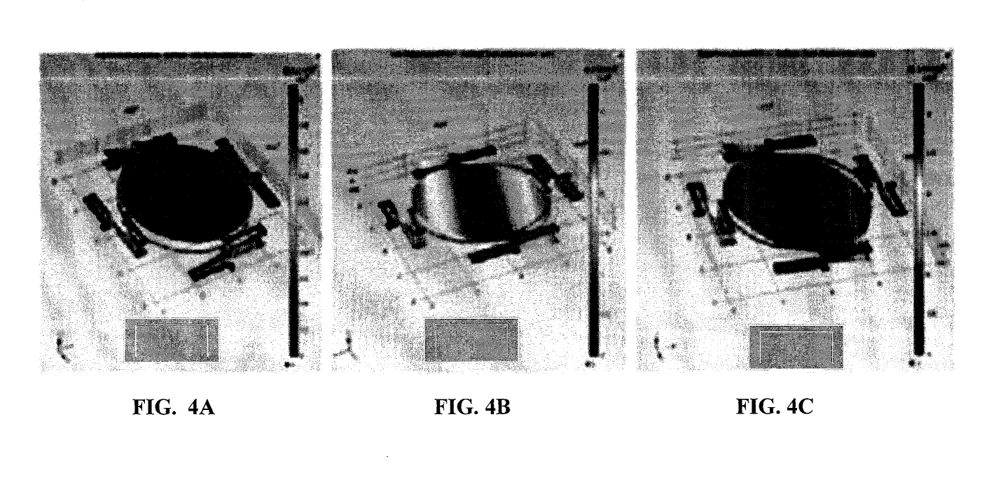

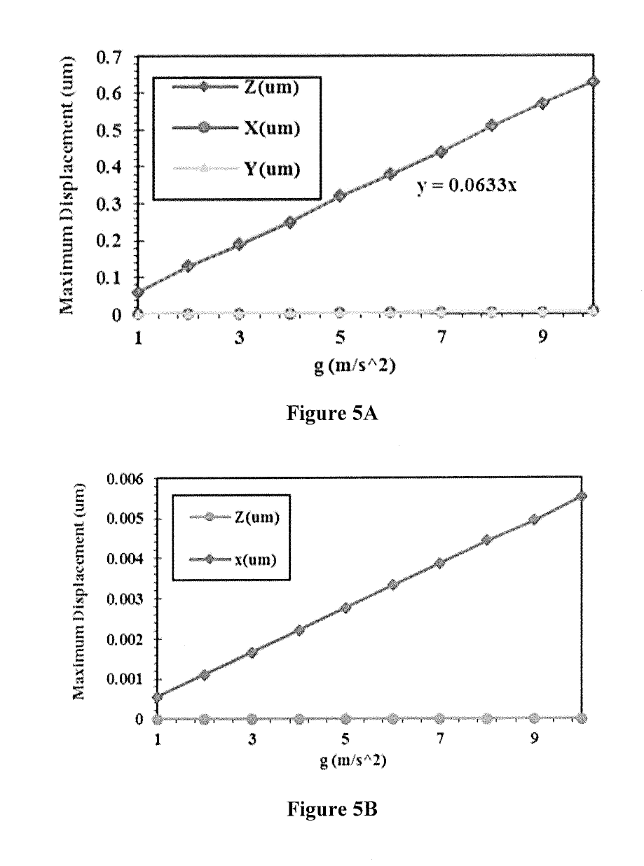

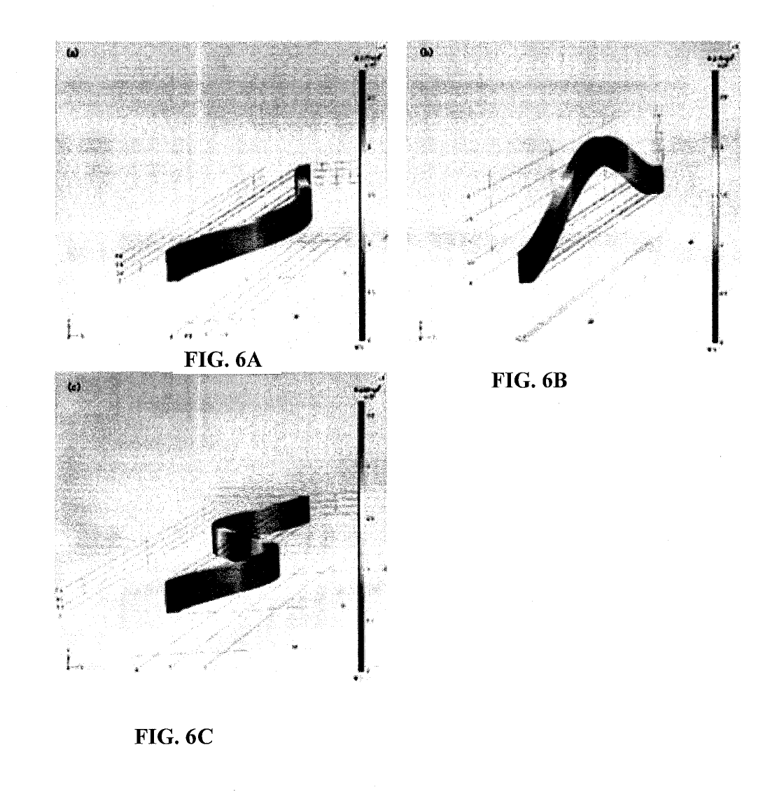

FIGS. 4A, 4B, and 4C illustrate the first three vibration modes of the inertia sensor and their corresponding resonance frequency values. The three calculated fundamental vibration modes are: 2.1 kHz, 3.6 kHz, and 3.6 kHz, respectively. The maximum displacement of the disk in the out-of-plane (z-direction) and in-plane (x-y direction) is calculated using a body load model ranging from 1 g to 10 g. FIG. 5A shows the maximum displacement of the inertia sensor when a body force is acting on the z-direction, when the displacement values in the z-direction have the highest values which is consistent with the modal analysis results. This shows that the lowest energy barrier of the system is in the z-direction. In addition, FIGS. 4A, 4B, and 4C indicate a very small displacement in the in-plane direction under this z-loaded force that recorded ˜1.3% cross axis sensitivity. Since the differential gap between the disk and the waveguides is restricted to 1 μm in this example, the gap spacing was extrapolated for 16 g in FIG. 4A. The maximum displacement is Z=1 μm and zero spacing between the disk and waveguide was achieved. Therefore, 16 g is the highest operational dynamic range of the inertia sensor in this particular example embodiment. From the numerical results 1 g-10 g was the optimum sensor dynamic range to operate the system safely and avoid any collapse or restriction. FIG. 5B illustrates the maximum displacement of the inertia sensor when it is loaded by an in-plane force, and the displacement values are very small and consistent with the modal analysis that give the z-direction the maximum displacement values. This demonstrated that any work exerted on the inertia sensor solely resulted in the z-displacement detection of an inertia sensor. In FIGS. 6A, 6B, and 6C, the three vibrational modes of the suspended beam (Si3N4 waveguide) are: Mode 1 with 1 MHz, Mode 2 with 2.2 MHz, and Mode 3 with 2.8 MHz.

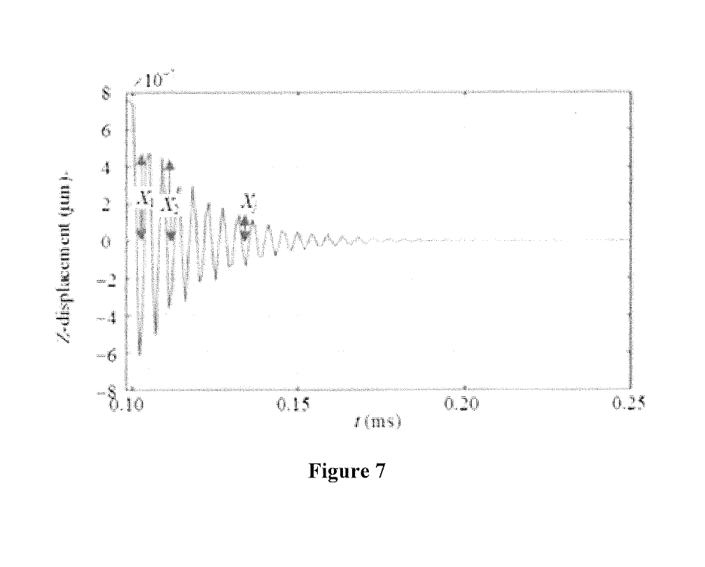

A logarithmic decrement approach is used to give an approximation of the sensor damping and quality factor. This approach depends on measuring the transient response of the structure when subjected to a sudden acceleration. FIG. 7 shows the z-displacement of the proof mass center as a function of time when a rectangle pulse of 0.1 ms width is applied to the inertia sensor under atmospheric condition (an air box surrounding the structure is designed and fluid-mechanics interaction is detected in the inertia sensor area). By measuring the ratio of any two successive amplitudes (X1 and X2 time difference) as shown in FIG. 7, the logarithmic decrement (δ) is calculated. Then, it can be shown that the damping ratio (ζ) is calculated in Equation [1].

$$ζ = \frac{δ}{\sqrt{{δ}^{2} + 4 {π}^{2}}} \qquad [ 1 ]$$

By plotting log (Xj) Vs j where j=1, 2 . . . the slope δ is calculated as 0.4. By substituting δ value in Equation [1], the value of ζ=0.07, the system is underdamped with a quality factor

$$Q = \frac{1}{2 * ζ} \text{∼} 7.$$

The proof mass settled after 0.25 ms which showed its utility in vibrating analysis devices.

The optical waveguides are designed using relatively low-index-contrast Si₃N₄ waveguides. The optical structure is flip-chipped on top of the IMU proof mass. In this configuration, the evanescent field of the optical waveguide interacts with the top surface of the proof mass. The larger the interaction of the optical fields with the proof mass, the greater the scattering of the optical mode in the waveguide which will result in attenuation of the optical signal.

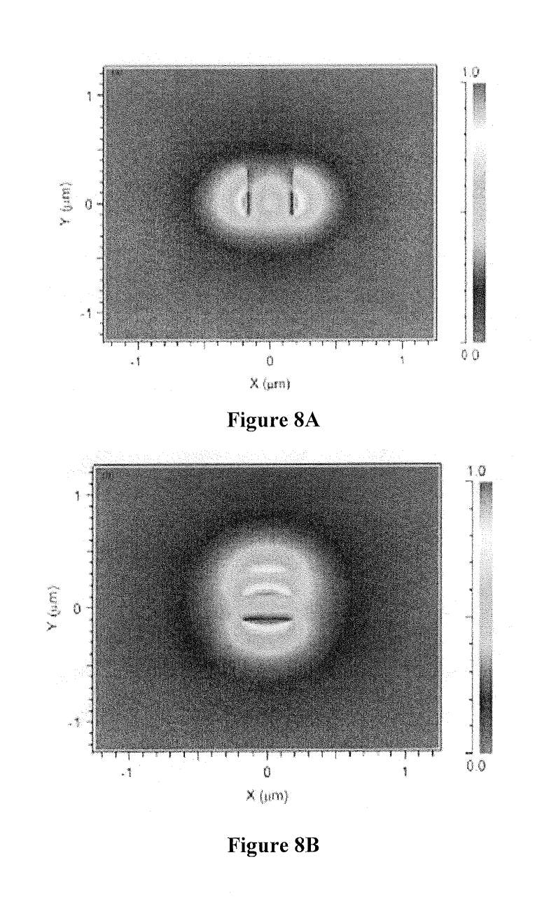

As the mass vibrates in the out-of-plane dimensions, it will get closer or farther away from the waveguide. This vibration can be detected as a modulation of the optical signal intensity. To maximize the interaction between the two platforms, the width of the waveguide is reduced and the bottom SiO₂ cladding is completely etched away below the waveguide leaving a suspended Si₃N₄ with top SiO₂ cladding structure. In this design, the Si₃N₄ waveguide has cross section dimensions of W X H=350×220 nm². The oxide box thickness is 2 μm. FIG. 8 shows the mode shapes TE and TM of a waveguide with W=0.35 μm using the Si₃N₄/SiO₂ waveguide.

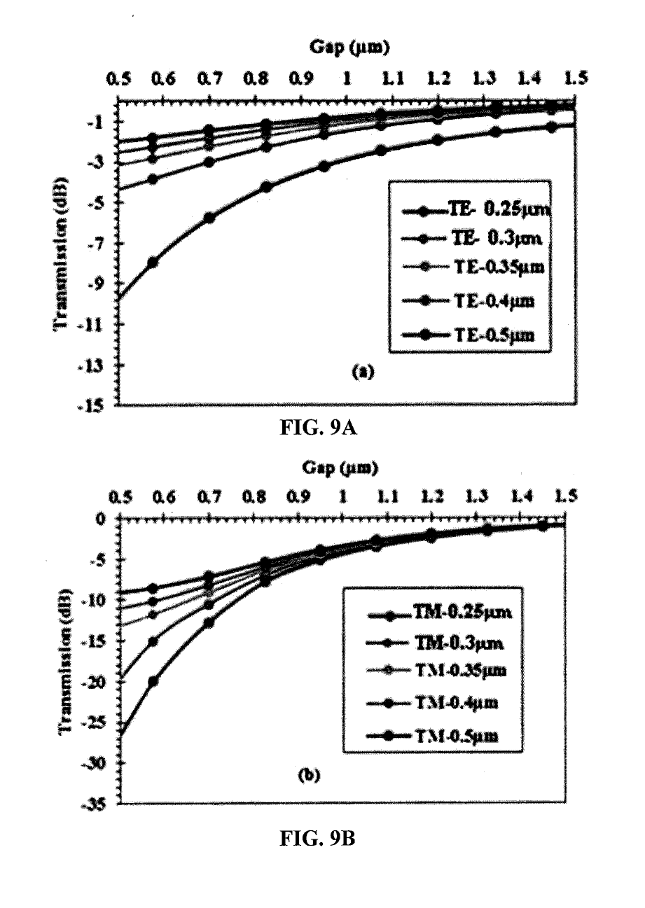

Numerical simulations of optically enabled micro-disk inertia sensor design were used to compute the leakage of the TE and TM polarizations propagating in a 50 μm long waveguide as a function of a gap between the two wafers and for a scan of waveguide width. The simulation results of the sensitivity of the out-of-plane disk movement are shown in FIGS. 9(a)-9(b), at a waveguide length of 50 μm for TE mode (FIG. 9(a)) and a TM mode (FIG. 9(b)). The sensitivity of the device is defined as the attenuation of a light signal due to the mechanical movement of the disk.

As shown in FIGS. 9A and 9B, TE and TM modes have clearly distinct sensitivity behavior. A high detection capability up to 25 dB/μm (or normalized sensitivity 0.5 dB/μm²) was achieved by using TM mode and a narrow waveguide of width 0.25 μm. In both polarizations, the sensitivity has a low value for a gap more than 1 μm, however as the disk becomes closer to the waveguide with gap spacing below 1 μm TM mode becomes highly sensitive. The gap spacing was calculated by monitoring the intensity of each polarization or the ratio between them.

In applied practices, a tap from the light source (˜6%) can be used as a monitor of the actual optical power launched from the laser. The variation of the signal at the output of the accelerometer waveguide due to the disk displacement is then compared to this reference monitor measurement.

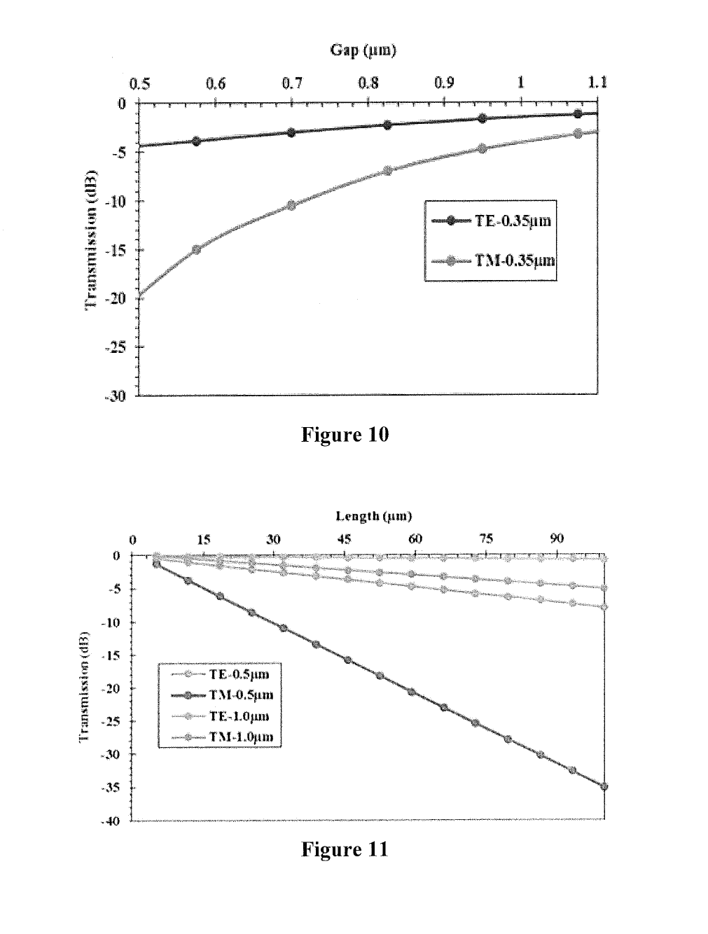

The TE and TM modes of 0.35 μm waveguide width are shown in FIG. 10 when the gap scan was reduced to 1.1 μm to define the operational regime of the device where the sensitivity detection is maximum. In addition, the ranges are approximately linear for a readout circuit in an experimental setup. The fabricated perspective wider waveguide with 0.35 μm has improved mechanical stability and increased its high sensitivity value.

Further, TE mode can also be used for narrow gap detection where the waveguide is designed to be longer than 50 μm. The power leakage as a function of waveguide length for both 0.5 μm and 1.0 μm gaps of 0.35 μm waveguide width is shown in FIG. 11.

Based on these numerical results, the optical integrated waveguide design appears to have an accurate and a large dynamic range detection of the out-of-plane displacement as shown in FIG. 11. Two sets of straight waveguides are demonstrated depending upon the intended use of the micro-opto-mechanical inertia sensor. A straight waveguide having a TM component of 50 μm (L×W=50×0.35 μm²) was used to detect the course movement. The second straight waveguide structure having a TM component of 100 μm (L×W=100×0.35 μm²) was used to detect the fine movement of the disk. With this configuration, it was demonstrated that the novel optically enabled micro-disk inertia sensor was capable to successfully measure a tiny displacement of <0.05 μm that corresponds to sub-g resolution over 10 g range.

The optically enabled z-axis micro-disk inertia sensor has a disk-shaped proof mass integrated on top of an optical waveguide. Numerical simulations showed that the optical power of a laser beam propagating in a narrow silicon nitride (Si₃N₄) waveguides located under the disk is attenuated in response to the vertical movement of the micro-disk. The high leakage power of the TM mode can effectively be used to detect a dynamic range of 1 g-10 g (g=9.8 m/s²). At rest, the waveguide is kept at a nominal gap of 1 μM from the proof mass. The wave guide is adiabatically tapered to a narrow dimension of W×H=350×220 nm² in the region where the optical mode is intended to interact with the proof mass. The bottom cladding of the inertia sensor is completely etched away to suspend the waveguide and improve the optical interaction with the proof mass. The optically enabled micro-disk inertia sensor has a high sensitivity of 3 dB/g when a 50 μm long waveguide is used (normalized sensitivity 0.5 dB/μm²) for the vertical movement detection.

The foregoing is illustrative of the present invention and is not to be construed as limiting thereof. Although a few example embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A micro-opto-mechanical sensor device comprising:
a substrate;
a moveable structure on the substrate and supported by a plurality of flexible supports, the moveable structure being spaced apart from the substrate; and
a passive optical waveguide between the moveable structure and the substrate, wherein movement of the moveable structure attenuates light in the optical waveguide.

2. The micro-opto-mechanical sensor device of claim 1, wherein the optical waveguide comprises a core comprising silicon (Si) or silicon nitride (Si₃N₄).

3. The micro-opto-mechanical sensor device of claim 2, wherein the optical waveguide comprises an outer cladding layer around the optical waveguide core, and the outer cladding layer is reduced or removed on a side of the optical waveguide core that is adjacent the substrate and opposite the moveable structure.

4. The micro-opto-mechanical sensor device of claim 3, wherein the substrate comprises a silicon-substrate photonics layer.

5. The micro-opto-mechanical sensor device of claim 4, further comprising
a layer on the substrate; and
a cavity between the substrate and the layer, wherein the moveable structure is in the cavity between the substrate and the layer.

6. The micro-opto-mechanical sensor device of claim 5, wherein the layer comprises a silicon-substrate inertia measurement unit (IMU) platform layer.

7. The micro-opto-mechanical sensor device of claim 1, wherein the optical waveguide is configured to transmit at least one of transverse electric (TE) or transverse magnetic (TM) optical polarizations.

8. The micro-opto-mechanical sensor device of claim 1, wherein the optical waveguide is birefringent.

9. The micro-opto-mechanical sensor device of claim 1, wherein a transmission of light in the optical waveguide is attenuated in response to movement in the z-direction of the moveable structure.

10. The micro-opto-mechanical sensor device of claim 1, wherein the moveable structure is configured to move in an x-, y-, and z-direction.

11. The micro-opto-mechanical sensor device of claim 1, wherein the moveable structure comprises a disk.

12. The micro-opto-mechanical sensor device of claim 1, wherein the plurality of flexible supports comprises serpentine springs.

13. The micro-opto-mechanical sensor device of claim 1, wherein the operational dynamic range is between about 1 gram and about 10 grams.

14. The micro-opto-mechanical sensor device of claim 1, wherein the optical waveguide is adiabatically tapered in a region adjacent the moveable structure.

15. The micro-opto-mechanical sensor device of claim 1, further comprising at least a first and a second optical component, the first optical component being configured to transmit light to the optical waveguide, and the second optical component being configured to transmit light from the waveguide to a photodetector.

16. A method for sensing with a micro-opto-mechanical sensor device, the method comprising:
providing micro-opto-mechanical sensor device comprising:
a substrate;
a moveable structure on the substrate and supported by a plurality of flexible supports, the moveable structure being spaced apart from the substrate; and
a passive optical waveguide between the moveable structure and the substrate;
detecting light from the optical waveguide via a photodetector; and
determining a movement of the sensor device responsive to the light from the optical waveguide.

17. The method of claim 16, wherein the optical waveguide comprises a core comprising silicon (Si) or silicon nitride (Si₃N₄).

18. The method of claim 17, wherein the optical waveguide comprises an outer cladding layer around the optical waveguide core, and the outer cladding layer is reduced or removed on a side of the optical waveguide core that is adjacent the substrate and opposite the moveable structure.

19. The method of claim 16, wherein the optical waveguide is adiabatically tapered in a region adjacent the moveable structure.

20. The method of claim 16, wherein the optical waveguide is birefringent.
